(19) United States
(12) Patent Application Publication
(10) Pub. No.: US 2009/0234785 A1
(43) Pub. Date: Sep. 17, 2009

(54) SYSTEM AND METHOD FOR EXERCISING A REPRESENTATION TO INDICATE SOLUTIONS

(75) Inventor: David Charles Gross, Decatur, AL (US)

Correspondence Address: LAW OFFICE OF DONALD D. MONDUL, 3060 BONSAI DRIVE, PLANO, TX, 75093, US

(73) Assignee: BOEING COMPANY, A CORPORATION OF DELAWARE, Chicago, IL (US)

(21) Appl. No.: 12/049,930

(22) Filed: Mar. 17, 2008

(51) Int. Cl. G06N 3/12; G06F 17/16

(52) U.S. Cl. 706/13; 703/2

(57) ABSTRACT

A system for exercising a representation employing relationships among a plurality of input values to indicate solutions includes: an output controller unit coupled with the representation and presenting output values in response to receiving selected solutions from the representation; and an input controller unit coupled with the output controller unit and with the representation. The input controller unit presents a succession of the input values to the representation. The input controller unit receives indication of the output values from the output controller unit. The input controller unit selects the succession of input values in response to convergence by the output values.

### FIELD

The present disclosure is directed to evaluating portrayals or representations of systems, apparatuses and the like. The present disclosure is especially directed to exercising a portrayal or representation such as a model or a simulation employing a plurality of input values to indicate solutions by the portrayal or representation.

### BACKGROUND

Computer-based representations or portrayals such as, by way of example and not by way of limitation, models and simulations may provide answers to questions about the behavior of the systems that they represent. However, to yield useful results from the representation or portrayal the questions must be carefully posed. Such posing may be effected by the selection of values for input parameters to a representation or portrayal.

Some parameters may configure a represented system of interest such as, by way of example and not by way of limitation, fuel capacity. Some parameters may define operational scenario values such as, by way of example and not by way of limitation, distance to be traveled. Some parameters may define inputs from humans such as, by way of example and not by way of limitation, operators and targets. The selection of the appropriate values for inputs may presently be a difficult process requiring substantial a priori insight into the nature of answers likely to result and insight into difficult-to-scale procedures such as design of experiments.

Exercises of representations or portrayals may be complicated and expensive to set up and correctly utilize. The requisite complication and expense may be so great that developing exercise plans may be a significant barrier to the use of representations or portrayals. An approach that seeks to evaluate or exercise all possible values that may pertain to a represented system may be overwhelming in terms of cost and complexity.

Alternatively, users of representations and portrayals such as models and simulations may select hand-crafted input configurations intended to explore particular regions of a solution space for a represented system by no formal method. Hand-crafted input configurations may be essentially educated guesses about how the model or simulation will respond and may not provide a rigorous solution to a query regarding, by way of example and not by way of limitation, where a model or simulation may predict interesting behavior in a represented system. Hand-crafted input configurations may focus on a user's expectation about a single output of the representation or simulation, neglecting potentially interesting parts of the solution space in other output variables.

Finally, it may not be possible in either design of experiments or hand-crafted approaches to quantify uncertainty associated with the results, e.g., whether or not an interesting or significant result has been overlooked.

There is a need for a system and method for exercising a representation to indicate solutions that does not depend on a priori designs for model or simulation input variables.

There is a need for a system and method for exercising a representation to indicate solutions that creates representation inputs based on results from the representation.

There is a need for a system and method for exercising a representation to indicate solutions that does not require knowledge, insight, or expectations about a representation's solution space.

There is a need for a system and method for exercising a representation to indicate solutions that quantifies the uncertainty resulting from the possibility that some interesting or significant result has been overlooked.

### SUMMARY

A system for exercising a representation employing relationships among a plurality of input values to indicate solutions includes: an output controller unit coupled with the representation and presenting output values in response to receiving selected solutions from the representation; and an input controller unit coupled with the output controller unit and with the representation. The input controller unit presents a succession of the input values to the representation. The input controller unit receives indication of the output values from the output controller unit. The input controller unit selects the succession of input values in response to convergence by the output values.

A method for exercising a representation employing relationships among a plurality of input values to indicate solutions includes: (a) In no particular order: (1) providing an output controller unit coupled with the representation; and (2) providing an input controller unit coupled with the output controller unit and with the representation. (b) Operating the output controller unit to effect presenting output values in response to receiving selected solutions from the representation. (c) Operating the input controller unit to effect presenting a succession of input values to the representation. (d) Operating the input controller unit to effect receiving indication of the output values from the output controller unit. (e) Operating the input controller unit to effect selecting the succession of input values in response to convergence by the output values.

It is, therefore, a feature of the present disclosure to present a system and method for exercising a representation to indicate solutions that does not depend on a priori designs for model or simulation input variables.

It is a further feature of the present disclosure to present a system and method for exercising a representation to indicate solutions that creates representation inputs based on results from the representation.

It is another feature of the present disclosure to present a need for a system and method for exercising a representation to indicate solutions that does not require knowledge, insight, or expectations about a representation's solution space.

It is yet another feature of the present disclosure to present a need for a system and method for exercising a representation to indicate solutions that quantifies the uncertainty resulting from the possibility that some interesting or significant result has been overlooked.

Further features of the present invention will be apparent from the following specification and claims when considered in connection with the accompanying drawings, in which like elements are labeled using like reference numerals in the various figures, illustrating the preferred embodiments of the disclosure.

### BRIEF DESCRIPTION OF THE DRAWINGS

FIG. 1 is a schematic illustration of a first embodiment of the present disclosure.

FIG. 2 is a schematic illustration of a second embodiment of the present disclosure.

FIG. 3 is a flow chart illustrating the method of the present disclosure.

### DETAILED DESCRIPTION

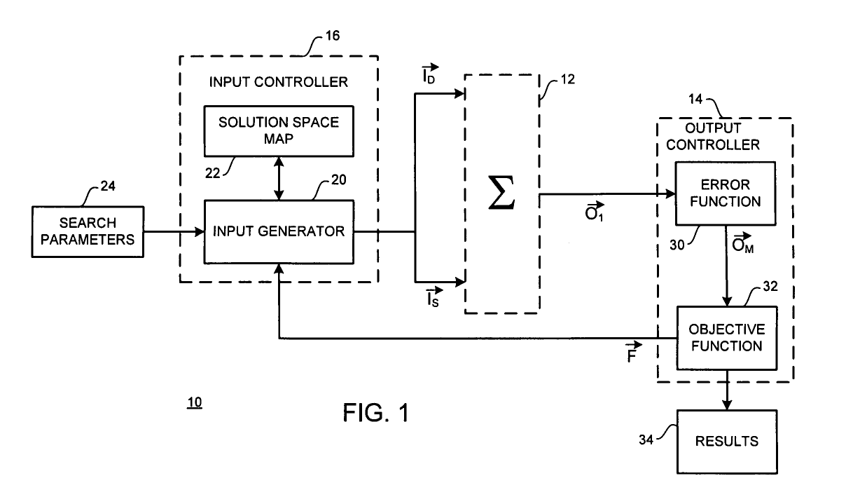

FIG. 1 is a schematic illustration of a first embodiment of the present disclosure. In FIG. 1, a system 10 may include a representation or portrayal unit 12, an output controller unit 14 and an input controller unit 16.

The collection of all input values for a specific use of a representation or portrayal unit 12 such as, by way of example and not by way of limitation, a model or simulation may be referred to as an “exercise”. Such exercises may be performed for a wide variety of applications domains including, by way of example and not by way of limitation, defense, space exploration, medicine, environment, economy, communication, manufacturing business processes, training, sociological, entertainment, and animation. Exercises may be performed for a wide variety of purposes including, by way of example and not by way of limitation, concept exploration, requirements analysis, solution architecture design, detailed design, manufacturing, integration, verification, and validation.

Input controller unit 16 may include an input value generator unit 20 coupled with a solution space map unit 22. Input value generator unit 20 may be coupled with representation unit 12 for providing input values to representation unit 12. Input generator unit 20 may also be coupled with output controller unit 14 for receiving indications of output values from output controller unit 14. A search parameter providing unit 24 may be coupled with input controller unit 16, and specifically may be coupled with input value generator unit 20 for providing beginning input parameters for use by input value generator unit 20 when initiating an exercise with representation unit 12. Solution space map 22 may serve to provide a sample space of available input values for use by input value generator unit 20, may serve to keep track of input values already used in an exercise, may serve to keep track of convergence or other features of indications of output values or solutions from output controller unit 14 or may perform a combination of tracking input values, convergence or other features or indications or values.

Input values may be provided by input value generator unit 20 to representation unit 12 in the form of static input values or dynamic input values. Static input values may be unchanging values for the duration of a particular exercising of representation unit 12 and may be in a vector form, as indicated by the notation \vec{I_{S}} in FIG. 1. Dynamic input values may be changing values provided for exercising representation unit 12 and may be in a vector form, as indicated by the notation \vec{I_{D}} in FIG. 1.

Representation unit 12 may manipulate input values \vec{I_{S}}, \vec{I_{D}} to present a representation or simulation output value which may be in a vector form, as indicated by the notation \vec{O₁} in FIG. 1.

Output controller unit 14 may include an error function unit 30 coupled with an objective function unit 32. Error function unit 30 may be coupled with representation unit 12 for receiving output values \vec{O₁}. Error function unit 30 may be employed as a convergence detector unit recording changes between successive output values \vec{O₁} received from representation unit 12. System 10 may prefer to achieve a predetermined level of convergence among or between output values \vec{O₁} before having input value generator unit 20 select input values \vec{I_{S}}, \vec{I_{D}} from another solution space in solution space map 22 than is presently providing input values \vec{I_{S}}, \vec{I_{D}}. Objective function unit 32 may receive multi-run output values from error function unit 30. Multi-run output values may be in a vector form, as indicated by the notation \vec{O_{M}} in FIG. 1. Objective function unit 32 may perform predetermined treatments of multi-run output values \vec{O_{M}} for making decisions based upon multi-run output values \vec{O_{M}}. First selected of those decisions may be presented to a results unit 34 for storage to support later uses. Second selected of those decisions may be provided to input controller unit 16 for use by input value generator unit 20 to select subsequent input values \vec{I_{S}}, \vec{I_{D}} for use by representation 12. Second selected decisions may be provided to input controller unit 16 in terms of figures of merit, which may be expressed in vector format, as indicated by the notation \vec{F} in FIG. 1.

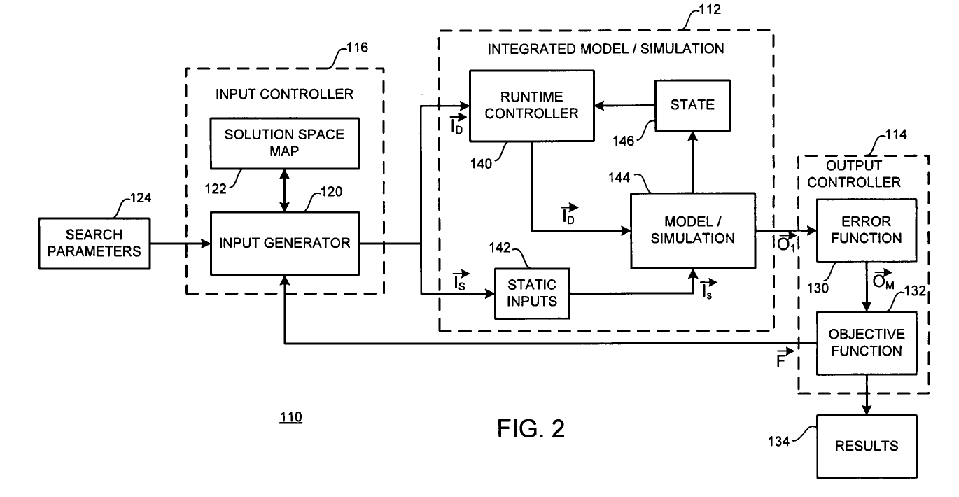

FIG. 2 is a schematic illustration of a second embodiment of the present disclosure. In FIG. 2, a system 110 may include a representation or portrayal unit 112, an output controller unit 114 and an input controller unit 116.

Input controller unit 116 may include an input value generator unit 120 coupled with a solution space map unit 122. Input value generator unit 120 may be coupled with representation unit 112 for providing input values to representation unit 112. Input generator unit 120 may also be coupled with output controller unit 114 for receiving indications of output values from output controller unit 114. A search parameter providing unit 124 may be coupled with input controller unit 116, and specifically may be coupled with input value generator unit 120 for providing beginning input parameters for use by input value generator unit 120 when initiating an exercise with representation unit 112. Solution space map 122 may serve to provide a sample space of available input values for use by input value generator unit 120, may serve to keep track of input values already used in an exercise, may serve to keep track of convergence or other features of indications of output values or solutions from output controller unit 14 or may perform a combination of tracking input values, convergence or other features or indications or values.

Input values may be provided by input value generator unit 120 to representation unit 112 in the form of static input values or dynamic input values. Static input values may be unchanging values for the duration of a particular exercising of representation 112 and may be in a vector form, as indicated by the notation \vec{I_{S}} in FIG. 2. Dynamic input values may be changing values provided for exercising representation unit 112 and may be in a vector form, as indicated by the notation \vec{I_{D}} in FIG. 2.

Representation unit 112 may manipulate input values \vec{I_{S}}, \vec{I_{D}} to present a representation or simulation output value which may be in a vector form, as indicated by the notation \vec{O₁} in FIG. 2.

Representation unit 112 may include a runtime controller unit 140 coupled with input value generator unit 120 for receiving dynamic input values \vec{I_{D}}. Representation unit 112 may include a static input unit 142 coupled with input value generator unit 120 in input controller unit 116 for receiving static input values \vec{I_{S}}. Representation unit 112 may also include a model/simulation unit 144 coupled with runtime controller unit 140 and with static input unit 142 for receiving input values \vec{I_{S}}, \vec{I_{D}}. A state unit 146 may relate information regarding model/simulation unit 144 to runtime controller unit 140. Model/simulation unit 144 may be coupled for providing output values \vec{O₁} to output controller unit 114.

Output controller unit 114 may include an error function unit 130 coupled with an objective function unit 132. Error function unit 130 may be coupled with model/simulation unit 144 in representation unit 112 for receiving output values \vec{O₁}. Error function unit 130 may be employed as a convergence detector unit recording changes between successive output values \vec{O₁} received from representation 112. System 110 may prefer to achieve a predetermined level of convergence among or between output values \vec{O₁} before having input value generator unit 120 select input values \vec{I_{S}}, \vec{I_{D}} from another solution space in solution space map 122 than is presently providing input values \vec{I_{S}}, \vec{I_{D}}. Objective function unit 132 receives multi-run output values from error function unit 130. Multi-run output values may be in a vector form, as indicated by the notation \vec{O_{M}} in FIG. 2. Objective function unit 132 may perform predetermined treatments of multi-run output values \vec{O_{M}} for making decisions based upon multi-run output values \vec{O_{M}}. First selected of those decisions may be presented to a results unit 134 for storage to support later uses. Results unit 134 may store first selected decisions in a map format relating input values with areas of interest or solutions defined by or in objective function unit 132. Second selected of those decisions may be provided to input controller unit 116 for use by input value generator unit 120 to select subsequent input values \vec{I_{S}}, \vec{I_{D}} for use by representation unit 112. Second selected decisions may be provided to input controller unit 116 in terms of figures of merit, which may be expressed in vector format, as indicated by the notation \vec{F} in FIG. 2.

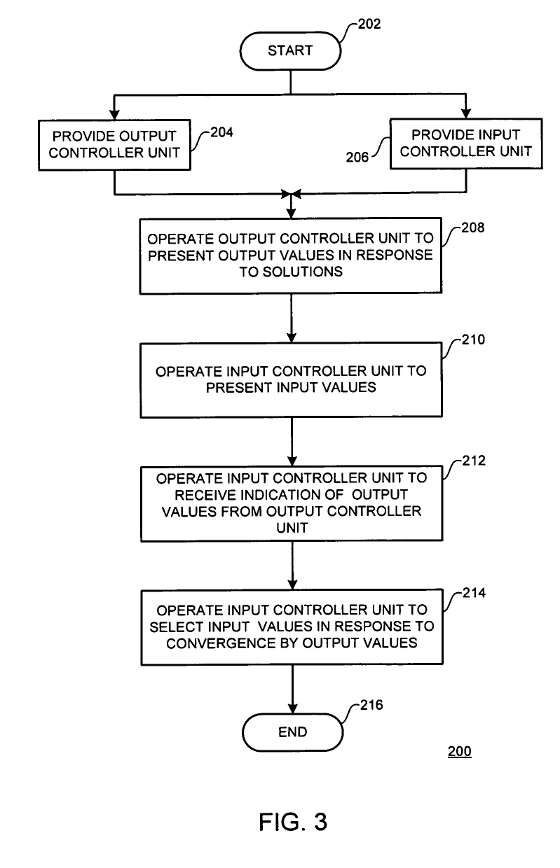

FIG. 3 is a flow chart illustrating the method of the present disclosure. In FIG. 3, a method 200 for exercising a representation employing relationships among a plurality of input values to indicate solutions may begin at a START locus 202. Method 200 may continue with, in no particular order: (1) providing an output controller unit coupled with the representation, as indicated by a block 204; and (2) providing an input controller unit coupled with the output controller unit and with the representation, as indicated by a block 206.

Method 200 may continue with operating the output controller unit to effect presenting output values in response to receiving selected the solutions from the representation, as indicated by a block 208.

Method 200 may continue with operating the input controller unit to effect presenting a succession of the input values to the representation, as indicated by a block 210.

Method 200 may continue with operating the input controller unit to effect receiving indication of the output values from the output controller unit, as indicated by a block 212.

Method 200 may continue with operating the input controller unit to effect selecting the succession of input values in response to convergence by the output values, as indicated by a block 214. Method 200 may terminate at an END locus 216.

The present disclosure may employ a genetic algorithm in an input value generator unit (20, 120). The mutation rate of the genetic algorithm may be based upon a map of the solution space (22, 122) that has been explored. The genetic algorithm may be used to generate both static and dynamic input values for representation unit (12, 112). The genetic algorithm may be an objective function based on outputs (\vec{O₁}) from representation unit (12, 112) to effect the presentation of input values (\vec{I_{S}}, \vec{I_{D}}) by value generator (20, 120) to representation unit (12). Variance of outputs (\vec{O₁}) from representation unit (12, 112) may be employed to control number of runs and the use of the objective genetic function.

These features may permit the present disclosure to search a solution space for a representation unit (12, 112) or portrayal such as a model or simulation without human intervention. The present disclosure may adjust how coarse or fine the examination of the solution space may be. The present disclosure may focus on particular areas of the solution space or may provide broad coverage. The present disclosure may adjust absolute or relative error in the results produced. The present disclosure may quantify uncertainty associated with results such as, by way of example and not by way of limitation, a possibility that an interesting or significant solution is missed. The present disclosure may permit improved effectiveness in employing representations or portrayals such as models and simulations by introducing a quantifiable rigor into their employment, and thereby may provide a significant opportunity for improving development and utilization of high technology products.

It is to be understood that, while the detailed drawings and specific examples given describe preferred embodiments of the disclosure, they are for the purpose of illustration only, that the apparatus and method of the disclosure are not limited to the precise details and conditions disclosed and that various changes may be made therein without departing from the spirit of the disclosure which is defined by the following claims:

I claim:

1. A system for exercising a representation employing relationships among a plurality of input values to indicate solutions; the system comprising: an output controller unit coupled with said representation and presenting output values in response to receiving selected said solutions from said representation; and an input controller unit coupled with said output controller unit and with said representation; said input controller unit presenting a succession of said input values to said representation; said input controller unit receiving indication of said output values from said output controller unit; said input controller unit selecting said succession of input values in response to convergence by said output values.

2. A system for exercising a representation employing relationships among a plurality of input values to indicate solutions as recited in claim 1 wherein said input controller unit employs a genetic algorithm having a mutation rate, and wherein said mutation rate is adjusted in response to said convergence by said output values.

3. A system for exercising a representation employing relationships among a plurality of input values to indicate solutions as recited in claim 1 wherein initial input values of said plurality of input values are identified to said input controller unit when initiating employment of the system.

4. A system for exercising a representation employing relationships among a plurality of input values to indicate solutions as recited in claim 1 wherein said plurality of input values is selected from a predetermined domain and range of input values.

5. A system for exercising a representation employing relationships among a plurality of input values to indicate solutions as recited in claim 1 wherein said output controller unit comprises an error detection unit coupled with said representation and an objective function unit coupled with said error detection unit and with said input controller unit.

6. A system for exercising a representation employing relationships among a plurality of input values to indicate solutions as recited in claim 1 wherein said input controller unit comprises an input value generator unit coupled with said output controller unit and with said representation and a solution space map unit coupled with said input value generator unit.

7. A system for exercising a representation employing relationships among a plurality of input values to indicate solutions as recited in claim 5 wherein said input controller unit comprises an input value generator unit coupled with said output controller unit and with said representation and a solution space map unit coupled with said input value generator unit.

8. A system for exercising a representation employing relationships among a plurality of input values to indicate solutions as recited in claim 1 wherein said representation comprises a runtime controller unit coupled with said input controller unit for receiving dynamic input values of said plurality of input values, a static input unit coupled with said input controller unit for receiving static input values of said plurality of input values, a representation operational unit coupled with said runtime controller unit and said static input unit and a state indicating unit coupled with said representation operational unit and said runtime controller unit; said representation operational unit being coupled for presenting said output values to said output controller unit.

9. A system for exercising a representation employing relationships among a plurality of input values to indicate solutions as recited in claim 8 wherein said output controller unit comprises an error detection unit coupled with said representation and an objective function unit coupled with said error detection unit and with said input controller unit, and wherein said input controller unit comprises an input value generator unit coupled with said output controller unit and with said representation and a solution space map unit coupled with said input value generator unit.

10. A system for exercising a representation employing relationships among a plurality of input values to indicate solutions as recited in claim 9 wherein initial input values of said plurality of input values are identified to said input controller unit when initiating employment of the system.

11. A system for exercising a representation employing relationships among a plurality of input values to indicate solutions as recited in claim 10 wherein said plurality of input values is selected from a predetermined domain and range of input values.

12. An apparatus for exercising a plurality of values to indicate behavior of a represented system; the apparatus comprising: a portrayal unit for exemplifying said represented system; an output controller unit coupled with said portrayal unit and presenting output values in response to receiving solutions from said portrayal unit indicating solutions for selected input values of said plurality of values; and an input controller unit coupled with said output controller unit and with said portrayal unit; said input controller unit presenting a succession of said input values to said portrayal unit; said input controller unit receiving indication of said output values from said output controller unit; said input controller unit selecting said succession of input values in response to convergence by said output values.

13. A system for exercising a representation employing relationships among a plurality of input values to indicate solutions as recited in claim 12 wherein said input controller unit employs a genetic algorithm having a mutation rate, and wherein said mutation rate is adjusted in response to said convergence by said output values.

14. An apparatus for exercising a plurality of values to indicate behavior of a represented system as recited in claim 12 wherein said output controller unit comprises an error detection unit coupled with said portrayal unit and an objective function unit coupled with said error detection unit and with said input controller unit.

15. An apparatus for exercising a plurality of values to indicate behavior of a represented system as recited in claim 12 wherein said input controller unit comprises an input value generator unit coupled with said output controller unit and with said portrayal unit and a solution space map unit coupled with said input value generator unit.

16. An apparatus for exercising a plurality of values to indicate behavior of a represented system as recited in claim 12 wherein said input controller unit comprises an input value generator unit coupled with said output controller unit and with said portrayal unit and a solution space map unit coupled with said input value generator unit.

17. An apparatus for exercising a plurality of values to indicate behavior of a represented system as recited in claim 12 wherein said portrayal unit comprises a runtime controller unit coupled with said input controller unit for receiving dynamic input values of said plurality of input values, a static input unit coupled with said input controller unit for receiving static input values of said plurality of input values, a portrayal operational element coupled with said runtime controller unit and said static input unit and a state indicating unit coupled with said portrayal operational element and said runtime controller unit; said portrayal operational element being coupled for presenting said output values to said output controller unit.

18. An apparatus for exercising a plurality of values to indicate behavior of a represented system as recited in claim 17 wherein said output controller unit comprises an error detection unit coupled with said portrayal unit and an objective function unit coupled with said error detection unit and with said input controller unit, and wherein said input controller unit comprises an input value generator unit coupled with said output controller unit and with said portrayal unit and a solution space map unit coupled with said input value generator unit.

19. An apparatus for exercising a plurality of values to indicate behavior of a represented system as recited in claim 18 wherein initial input values of said plurality of input values are identified to said input controller unit when initiating employment of the system.

20. A method for exercising a representation employing relationships among a plurality of input values to indicate solutions; the method comprising:
(a) in no particular order:
(1) providing an output controller unit coupled with said representation; and
(2) providing an input controller unit coupled with said output controller unit and with said representation;
(b) operating said output controller unit to effect presenting output values in response to receiving selected said solutions from said representation;
(c) operating said input controller unit to effect presenting a succession of said input values to said representation;
(d) operating said input controller unit to effect receiving indication of said output values from said output controller unit; and
(e) operating said input controller unit to effect selecting said succession of input values in response to convergence by said output values.

21. A method for exercising a representation employing relationships among a plurality of input values to indicate solutions as recited in claim 20 wherein said input controller unit employs a genetic algorithm having a mutation rate, and wherein said mutation rate is adjusted in response to said convergence by said output values.

22. A method for exercising a representation employing relationships among a plurality of input values to indicate solutions as recited in claim 20 wherein initial input values of said plurality of input values are identified to said input controller unit when initiating employment of the system.

23. A method for exercising a representation employing relationships among a plurality of input values to indicate solutions as recited in claim 20 wherein said plurality of input values is selected from a predetermined domain and range of input values.
